(19) United States
(12) Patent Application Publication
(10) Pub. No.: US 2024/0173793 A1
(43) Pub. Date: May 30, 2024

(54) METHOD FOR CALCULATION, DEVICE FOR LASER PROCESSING, AND NON-TRANSITORY COMPUTER-READABLE STORAGE MEDIUM

(71) Applicant: Makeblock Co., Ltd., Shenzhen (CN)

(72) Inventor: Yuanxiu ZHANG, Shenzhen (CN)

(73) Assignee: Makeblock Co., Ltd., Shenzhen (CN)

(21) Appl. No.: 18/436,500

(22) Filed: Feb. 8, 2024

Related U.S. Application Data
(63) Continuation of application No. PCT/CN2022/113306, filed on Aug. 18, 2022.

(30) Foreign Application Priority Data
Aug. 18, 2021 (CN) 202110950243.1

(51) Int. Cl. B23K 26/042; B23K 26/03; B23K 26/60; B23K 26/70; G01B 11/00

(52) U.S. Cl. CPC B23K 26/042; B23K 26/032; B23K 26/60; B23K 26/702; G01B 11/002

(57) ABSTRACT

A method for calculating a starting point includes the following. A first coordinate system and a second coordinate system are established. The first coordinate system includes a CX-axis and is a coordinate system for a picture of a part to be processed. The picture of the part to be processed is captured. A first coordinate of a light spot on the CX-axis is obtained based on the picture. The light spot is formed by irradiating on the part to be processed by light. The second coordinate of the light spot in the second coordinate system is calculated based on the first coordinate as the starting point for processing. The method further relates to a device for laser processing and a non-transitory computer-readable storage medium.

### CROSS-REFERENCE TO RELATED DISCLOSURES

This application is a continuation of International Application No. PCT/CN2022/113306, filed Aug. 18, 2022, which claims priority to Chinese Patent Application No. 202110950243.1, filed Aug. 18, 2021, the entire disclosures of each of which are hereby incorporated by reference.

### FIELD

The disclosure relates to the field of laser processing, and specifically to a method for calculating a starting point for processing, a device for laser processing, and a non-transitory computer-readable storage medium.

### BACKGROUND

When a current device for laser processing performs laser processing, a starting point of laser processing is usually manually measured and recalibrated repeatedly.

The materials described in this section is merely background information as understood by the inventor and are not prior art to the claims in this disclosure, and are not admitted to the prior art by inclusion in this section.

### SUMMARY

In a first aspect, embodiments of the present disclosure provide a method for calculating the starting point for processing, which is performed by the device for laser processing and includes the following. A first coordinate system and a second coordinate system are established. The first coordinate system includes a CX-axis and is a coordinate system for a picture of a part to be processed. The picture of the part to be processed is captured, and a first coordinate of a light spot on the CX-axis in the first coordinate system is obtained based on the picture, where the light spot is formed by irradiating the part to be processed by light emitted from a light emitter of the device for laser processing. A second coordinate of the light spot in the second coordinate system is calculated based on the first coordinate, and the starting point for processing is determined based on the second coordinate.

In a second aspect, embodiments of the present disclosure further provide a device for laser processing. The device for laser processing includes a bearing table, a camera, and a light emitter. The bearing table is configured to bear a part to be processed. The camera is configured to capture a picture of the part to be processed. The light emitter is configured to emit light towards the bearing table to form a light spot on a surface of the part to be processed. The device for laser processing further includes a processor and a memory. The processor is electrically connected to the camera and the memory. The memory is configured to store program codes executable by the processor, and the program codes, when invoked and executed by the processor, are configured to cause the processor to perform the following. A first coordinate system and a second coordinate system are established. The first coordinate system includes a CX-axis and is a coordinate system for a picture of a part to be processed. The picture of the part to be processed is captured, and a first coordinate of a light spot on the CX-axis in the first coordinate system is obtained based on the picture, where the light spot is formed by irradiating the part to be processed by light emitted from a light emitter of the device for laser processing. A second coordinate of the light spot in the second coordinate system is calculated based on the first coordinate, and the starting point for processing is determined based on the second coordinate.

In a third aspect, embodiments of the present disclosure further provide a non-transitory computer-readable storage medium. The non-transitory computer-readable storage medium is configured to store executable program codes. The computer-executable program codes are configured to cause a computer to perform the following. A first coordinate system and a second coordinate system are established. The first coordinate system includes a CX-axis and is a coordinate system for a picture of a part to be processed. The picture of the part to be processed is captured, and a first coordinate of a light spot on the CX-axis in the first coordinate system is obtained based on the picture, where the light spot is formed by irradiating the part to be processed by light emitted from a light emitter of the device for laser processing. A second coordinate of the light spot in the second coordinate system is calculated based on the first coordinate, and the starting point for processing is determined based on the second coordinate.

### BRIEF DESCRIPTION OF THE DRAWINGS

To describe technical solutions of embodiments in the disclosure more clearly, the following will give a brief introduction to accompanying drawings used for describing the embodiments. Apparently, the accompanying drawings hereinafter described are merely some embodiments of the disclosure. Based on these drawings, those of ordinary skill in the art can also obtain other drawings without creative effort.

FIG. 1 is a schematic flowchart of a method for calculating a starting point for processing of an embodiment of the present disclosure.

FIG. 2 is a schematic flowchart of a method for calculating a starting point for processing of another embodiment of the present disclosure.

FIG. 3 is a schematic flowchart of a method for obtaining a relational expression of an embodiment of the present disclosure.

FIG. 4 is a structural block diagram of a device for laser processing of an embodiment of the present disclosure.

FIG. 5 is a structural block diagram of a device for laser processing of another embodiment of the present disclosure.

FIG. 6 is a schematic structural diagram of a device for laser processing of embodiments of the present disclosure.

FIG. 7 is a schematic exploded structural diagram of a device for laser processing of an embodiment of FIG. 6 of the present disclosure.

FIG. 8 is a schematic diagram illustrating a position relationship between a camera and a bearing table of a device for laser processing of embodiments of the present disclosure.

FIG. 9 is a block diagram of a circuit of a device for laser processing of embodiments of the present disclosure

### DETAILED DESCRIPTION

In order to enable a person of ordinary skill in the art to better understand embodiments of the present disclosure, the following will clearly and completely describe technical solutions of the embodiments of the present disclosure with reference to the accompanying drawings. Apparently, the embodiments described herein are merely some embodiments, rather than all embodiments, of the disclosure. Based on the embodiments described herein, all other embodiments obtained by those of ordinary skill in the art without creative effort shall fall within the protection scope of the disclosure.

The terms “first”, “second”, and the like used in the specification, the claims, and the accompanying drawings of the disclosure are used to distinguish different objects rather than describe a particular order. In addition, the terms “include”, and “comprise” as well as variations thereof are intended to cover non-exclusive inclusion. For example, a process, method, system, product, or device including a series of steps or units is not limited to the listed steps or units, but optionally also includes steps or units that are not listed, or optionally includes other steps or units that are inherent to the process, method, product or device.

The following will describe technical solutions of the embodiments of the present disclosure with reference to the accompanying drawings.

It is noted that, for ease of illustration, the same reference numerals denote the same components in the embodiments of the present disclosure, and for the sake of brevity, detailed descriptions of the same components are omitted in different embodiments.

In the case where a device for laser processing performs laser processing, a three-dimensional coordinate of a starting point for processing needs to be determined first, a laser head of the device for laser processing is then controlled to move to the starting point for processing based on the three-dimensional coordinate, and the processing is started from the starting point. However, a coordinate on a Z-axis (i.e., a direction perpendicular to a surface of a part to be processed) of the starting point for processing of the device for laser processing in the related art may be determined by measuring a distance between the part to be processed and the laser head or a distance between the part to be processed and a camera, etc., but coordinates on an X-axis and a Y-axis (the X-axis and the Y-axis are perpendicular to each other and are parallel to the part to be processed) are usually manually measured and recalibrated repeatedly, which greatly reduces the processing efficiency of the device for laser processing and degrades user experience.

As illustrated in FIG. 1, the embodiments of the present disclosure provide a method for calculating the starting point for processing, which is performed by the device for laser processing, and the method includes the following.

At S101, a first coordinate system and a second coordinate system are established. The first coordinate system includes a CX-axis and is a coordinate system for a picture of a part to be processed.

The second coordinate system may include an X-axis, a Y-axis and a Z-axis which are perpendicular to one another. A plane defined by the X-axis and Y-axis may be parallel to a bearing table of the device for laser processing.

Optionally, the first coordinate system for the picture of the part to be processed is established. The first coordinate system is a two-dimensional coordinate system and includes the CX-axis and a CY-axis. The CX-axis is perpendicular to the CY-axis. Optionally, the first coordinate system is a picture coordinate system, a unit of which is a pixel. Optionally, the picture may be captured by the camera of the device for laser processing.

Optionally, the second coordinate system for a space of the part to be processed is established. The second coordinate system is a three-dimensional coordinate system and includes the X-axis, the Y-axis, and the Z-axis. The X-axis is perpendicular to the Y-axis and Z-axis respectively, and the Y-axis is perpendicular to the Z-axis. The plane defined by the X-axis and the Y-axis is parallel to the bearing table of the device for laser processing or the part to be processed. A unit of the second coordinate system may be mm. In some embodiments, a point on the bearing table is used as an origin of the Z-axis in the second coordinate system, and two lines perpendicular to each other on a plane of the bearing table are implemented as the X-axis and the Y-axis in the second coordinate system.

At S102, the picture of the part to be processed is captured, and a first coordinate of a light spot on the CX-axis in the first coordinate system is obtained based on the picture. The light spot is formed on the part to be processed by light emitted from a light emitter of the device for laser processing.

Optionally, the part to be processed is disposed on the bearing table of the device for laser processing, and the picture of the part to be processed is captured by a picture capturing module such as the camera. The first coordinate of the light spot on the picture on the CX axis in the first coordinate system is obtained, in other words, a first coordinate of the light spot in the picture coordinate system is obtained. The light spot is formed by irradiating the part to be processed by the light emitted from the light emitter of the device for laser processing. It is noted that the light emitted from the light emitter irradiates on the part to be processed and forms the light spot on the part to be processed, and therefore the picture of the part to be processed obtained using the camera includes a picture of the light spot as well.

Optionally, the angle of incidence of the light emitted from the light emitter on the part to be processed or the bearing table is greater than 0°, more preferably greater than or equal to 45°. This allows the light spot irradiated on the surface of the part to be processed to change a position in the case where the thickness of the part to be processed varies. The coordinates of the light spot in the first coordinate system and the second coordinate system are thereby changed. As a result, the coordinate of the light spot in the second coordinate system is deduced based on the position or coordinate of the light spot in the first coordinate system.

At S103, a second coordinate of the light spot in the second coordinate system is calculated based on the first coordinate, and the second coordinate is used as the starting point for processing.

Optionally, the second coordinate of the light spot in the second coordinate system is calculated based on the first coordinate and a relation between the first coordinate and the second coordinate, and the second coordinate is used as the starting point for processing of the device for laser processing. Optionally, the second coordinate is a three-dimensional coordinate and includes an X-axis coordinate, a Y-axis coordinate, and a Z-axis coordinate.

In the method for calculating the starting point for processing of the embodiments of the present disclosure, the light spot is shed on the part to be processed, the picture of the part to be processed is obtained by the camera, and a coordinate of a position of the light spot (i.e., the coordinate of the starting point for processing) is obtained based on the coordinate of the light spot on the picture, so that the obtainment of the starting point for processing can be automated without the need for manual measurement and recalibration, therefore improving the efficiency of obtaining the starting point for processing, and thus improving the efficiency of the laser processing.

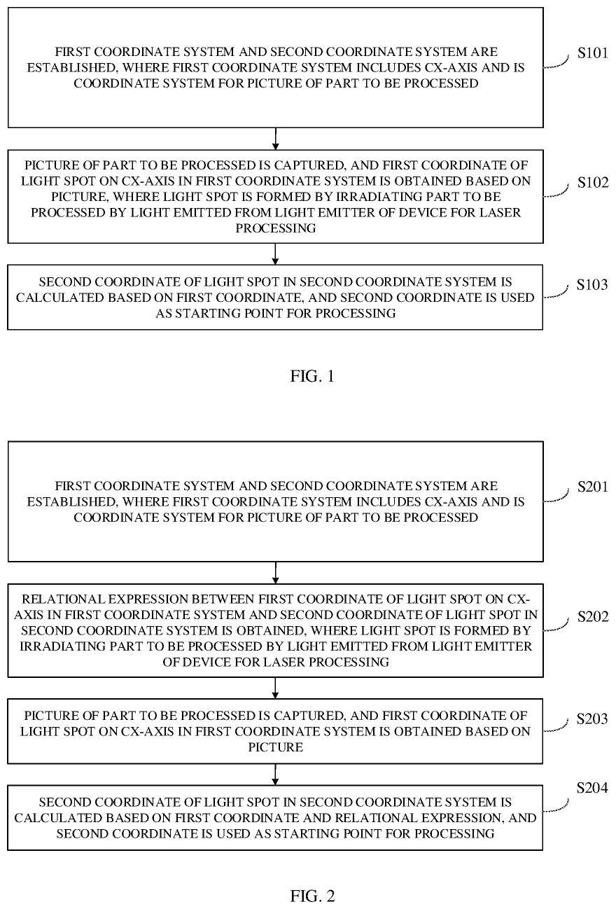

As illustrated in FIG. 2, another embodiment of the present disclosure provides a method for calculating a starting point for processing, which is performed by a device for laser processing, and the method includes the following.

At S201, a first coordinate system and a second coordinate system are established. The first coordinate system includes a CX-axis and is a coordinate system for a picture of a part to be processed.

The second coordinate system may include an X-axis, a Y-axis, and a Z-axis, which are perpendicular to one another. A plane defined by the X-axis and the Y-axis may be parallel to a bearing table of the device for laser processing.

For detailed descriptions of operations at S201, reference can be made to detailed descriptions of operations at S101 in the above embodiment, which will not be repeated here.

At S202, a relational expression between a first coordinate of a light spot on the CX-axis in the first coordinate system and a second coordinate of the light spot in the second coordinate system is obtained. The light spot is formed on the part to be processed by the light emitted from a light emitter of the device for laser processing.

Optionally, the light emitted from the light emitter of the device for laser processing irradiates on the part to be processed and forms the light spot on the part to be processed. The light spot may be an infrared light spot, an ultraviolet light spot, a red light spot, a blue light spot, or a violet light spot, or the like. Color of the light spot is not limited in the present disclosure.

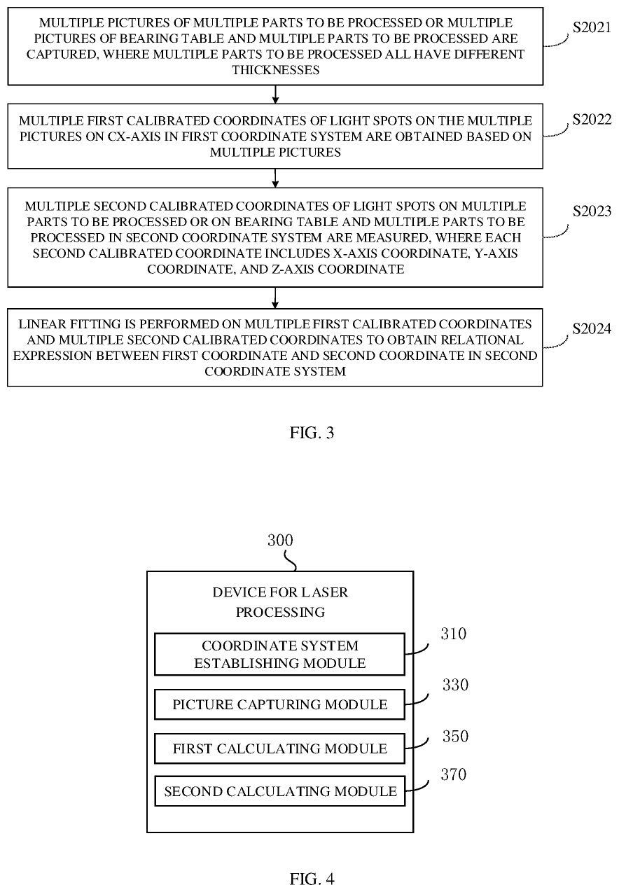

As illustrated in FIG. 3 as well, optionally, the relational expression between the first coordinate of the light spot on the CX axis in the first coordinate system and the second coordinate of the light spot in the second coordinate system is obtained as follows.

At S2021, multiple pictures of multiple parts to be processed or multiple pictures of the bearing table and multiple parts to be processed are captured. The multiple parts to be processed all have different thicknesses.

Optionally, the light emitter is turned on to make the light emitted from the light emitter irradiate and form the light spot on the bearing table or the part to be processed. The multiple parts to be processed of different thickness are disposed on the bearing table successively, and pictures of the bearing table and each of the parts to be processed are taken in turn using a picture capturing module such as a camera, therefore the multiple pictures are obtained and the multiple pictures each includes a picture of the light spot.

At S2022, multiple first calibrated coordinates (coordinates on the CX-axis) of light spots on pictures on the CX-axis in the first coordinate system are obtained based on the multiple pictures.

Optionally, a first calibrated coordinate of the light spot on each of the pictures on the CX-axis in the first coordinate system is obtained respectively based on the multiple pictures. The first calibrated coordinate may be obtained by manual measurement or picture identification.

At S2023, multiple second calibrated coordinates of light spots on the multiple parts to be processed or on the bearing table and the multiple parts to be processed in the second coordinate system are measured. Each second calibrated coordinate includes an X-axis coordinate, a Y-axis coordinate, and a Z-axis coordinate.

Optionally, the multiple second calibrated coordinates of the light spots on the multiple parts to be processed or on the bearing table and the multiple parts to be processed in the second coordinate system (such as the X-axis coordinate, the Y-axis coordinate, and the Z-axis coordinate of each light spot) are measured manually. Optionally, in a case where an origin of the second coordinate system is on the bearing table, thickness of the part to be processed is a coordinate of the light spot on the Z-axis in the second coordinate system.

At S2024, a linear fitting is performed on the multiple first calibrated coordinates and the multiple second calibrated coordinates to obtain the relational expression between the first coordinate and the second coordinate in the second coordinate system.

Optionally, a linear fitting is performed on Z-axis coordinates and CX-axis coordinates to obtain a relational expression (1) between Z and CX: Z=a*CX+b, where a and b are constants of the linear function. A linear fitting is performed on the Z-axis coordinates and X-axis coordinates to obtain a relational expression (2) between X and Z: X=c*Z+d, where c and d are constants of the linear function. A linear fitting is performed on the Z-axis coordinates and Y-axis coordinates to obtain a relational expression (3) between Y and Z: Y=e*Z+f, where e and f are constants of the linear function.

The relational expression between the first coordinate and the second coordinate includes the relational expression (1), the relational expression (2), and the relational expression (3).

In a specific embodiment, the relational expression between the first coordinate and the second coordinate is obtained as follows.
1) Pictures of the bearing table and the parts to be processed which have thickness of 3 mm, 6 mm, 9 mm, 12 mm, and 15 mm are captured, respectively.
2) The coordinates (first calibrated coordinates) of the light spots in the pictures in the first coordinate system are obtained. The coordinates are 861.3, 1117.8, 1372.2, 1620.7, 1877.1, and 2132.6, respectively.
3) Using a point on the bearing table as an origin of the Z-axis, the X-axis coordinates (of the second calibrated coordinates) of the light spots on the bearing table and the multiple parts to be processed in the second coordinate system are measured and obtained to be 194.1, 199.8, 205.4, 211.1, 216.7, and 222.4, respectively; the Y-axis coordinates (of the second calibrated coordinates) of the light spots on the bearing table and the multiple parts to be processed in the second coordinate system are measured and obtained to be 156.8, 155.7, 154.6, 153.5, 152.4, and 151.3, respectively; and the Z-axis coordinates (of the second calibrated coordinates) of the light spots on the bearing table and the multiple parts to be processed in the second coordinate system are measured and obtained to be 0.0, 3.0, 6.0, 9.0, 12.0, and 15.0, respectively.
4) The linear fitting is performed on the Z-axis coordinates and the CX-axis coordinates to obtain the relational expression (1) between Z and CX: Z=0.0118CX−10.15, where a=0.0118, b=−10.15. The linear fitting is performed on the Z-axis coordinates and the X-axis coordinates to obtain the relational expression (2) between X and Z: X=1.8833Z+194.10, where c=1.8833, d=194.10. The linear fitting is performed on the Z-axis coordinates and the Y-axis coordinates to obtain the relational expression (3) between Y and Z: Y=−0.3667Z+156.8, where e=−0.3667, f=156.8.

At S203, the picture of the part to be processed is captured, and the first coordinate of the light spot on the CX-axis in the first coordinate system is obtained based on the picture.

At S204, the second coordinate of the light spot in the second coordinate system is calculated based on the first coordinate and the relational expression, and the second coordinate is used as the starting point for processing.

For detailed descriptions of operations at S203 and S204, reference can be made to detailed descriptions of operations at S102 and S103 in the above embodiments, which will not be repeated here.

For the description of the same portion of this embodiment as the above embodiments, reference can be made to the above embodiments, which will not be repeated here.

As illustrated in FIG. 4, the embodiments of the present disclosure further provide a device 300 for laser processing. The device 300 for laser processing includes a coordinate system establishing module 310, a picture capturing module 330, a first calculating module 350, and a second calculating module 370. The coordinate system establishing module 310 is configured to establish a first coordinate system and a second coordinate system. The first coordinate system includes a CX-axis and is a coordinate system of a part to be processed. The second coordinate system includes an X-axis, a Y-axis, and a Z-axis which are perpendicular to one another. A plane defined by the X-axis and the Y-axis is parallel to a bearing table of the device 300 for laser processing. The picture capturing module 330 is configured to capture a picture of the part to be processed. The first calculating module 350 is configured to obtain a first coordinate of a light spot on the CX-axis in the first coordinate system based on the picture. The light spot is formed by irradiating the part to be processed by light emitted from a light emitter of the device 300 for laser processing. The second calculating module is configured to calculate a second coordinate of the light spot in the second coordinate system. The second coordinate is used as a starting point for processing.

For the same features of this embodiment as the above embodiments, reference can be made to the detailed descriptions in the above embodiments, which will not be repeated here.

As illustrated in FIG. 5, in some embodiments, the device 300 for laser processing further includes a relational expression calculating module 390. The relational expression calculating module 390 is configured to obtain a relational expression between the first coordinate on the CX-axis in the first coordinate system and the second coordinate in the second coordinate system.

As illustrated again in FIG. 5, in some embodiments, the picture capturing module 330 is further configured to capture multiple pictures of multiple parts to be processed or multiple pictures of the bearing table and the multiple parts to be processed. The multiple parts to be processed all have different thicknesses. The relational expression calculating module 390 includes a first calculating unit 391, a second calculating unit 393, and a fitting unit 395. The first calculating unit 391 is configured to obtain multiple first calibrated coordinates of light spots on the pictures on the CX-axis in the first coordinate system based on the multiple pictures. The second calculating unit 393 is configured to measure multiple second calibrated coordinates of light spots on the multiple parts to be processed or on the bearing table and the multiple parts to be processed in the second coordinate system. Each second calibrated coordinate includes an X-axis coordinate, a Y-axis coordinate, and a Z-axis coordinate. The fitting unit 395 is configured to perform a linear fitting on multiple first multiple calibrated coordinates and multiple second multiple calibrated coordinates to obtain the relational expression between the first coordinate and the second coordinate in the second coordinate system.

In this embodiment, the device is presented in the form of modules and units. “Module” and “unit” herein can refer to an application-specific integrated circuit (ASIC), a processor and a memory for executing one or more software or firmware programs, an integrated logic circuit, and/or other components that can achieve the above described functions.

For the same features of this embodiment as the above embodiments, reference can be made to the detailed descriptions in the above embodiments, which will not be repeated here.

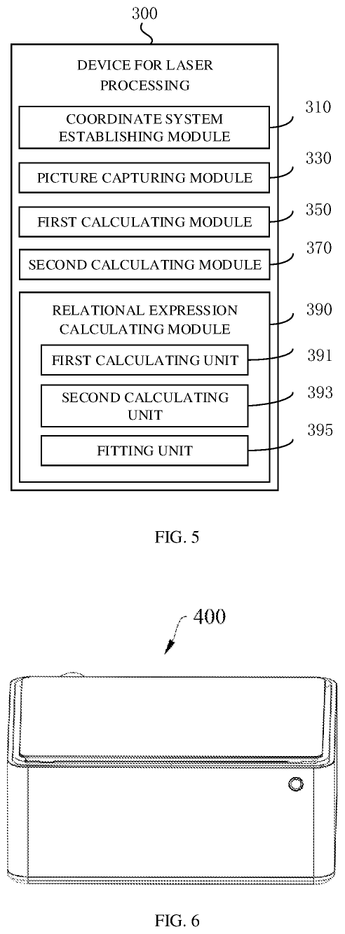

As illustrated in FIG. 6 to FIG. 9, the embodiments of the present disclosure further provide a device 400 for laser processing. The device 400 for laser processing includes a bearing table 410, a camera 430, and a light emitter 450. The bearing table 410 is configured to bear a part to be processed. The camera 430 is configured to capture a picture of the part to be processed. The light emitter 450 is configured to emit light towards the bearing table 410 to form a light spot on a surface of the part to be processed. The device 400 for laser processing further includes a processor 470 and a memory 490. The processor 470 is electrically connected to a camera module and the memory 490. The memory 490 is configured to store program codes executable by the processor 470, and the program codes, when invoked and executed by the processor 470, are configured to cause the processor to perform the method for calculating a starting point for processing of the embodiments of the present disclosure.

Optionally, the camera 430 may be, but is not limited to, a wide-angle camera, a zoom camera, or the like.

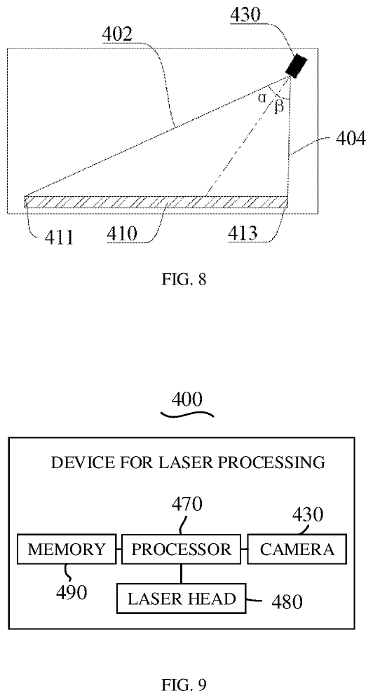

As illustrated in FIG. 8, in some embodiments, a plane defined by the camera 430 and a first end 411 of the bearing table 410 is a first plane 402, and a plane defined by the camera 430 and a second end 413 of the bearing table 410 is a second plane 404. An angle α between an optical axis of the camera 430 and the first plane 402 is equal to an angle β between the optical axis of the camera 430 and the second plane 404. This allows the picture of the part to be processed obtained by the camera 430 to have a better quality, so that the device 400 for laser processing can more accurately process the part to be processed. The term “optical axis” in this disclosure refers to an axis of symmetry of the camera 430 or an axis of symmetry of an optical system of the camera 430.

Optionally, the light emitter 450 may emit infrared light, ultraviolet light, red light, blue light, or violet light, or the like, in other words, the light emitter 450 is an infrared light source, an ultraviolet light source, a red light source, a blue light source, or a violet light source, or the like. The light spot may be an infrared light spot, an ultraviolet light spot, a red light spot, a blue light spot, or a violet light spot, or the like. Color of the light spot is not limited in the present disclosure.

In some embodiments, an angle between a centerline of the light emitter 450 and the bearing table 410 is less than or equal to 45°. In other words, an angle of incidence of light emitted by the light emitter 450 on the part to be processed or on the bearing table 410 is greater than or equal to 45°. Specifically, the angle between the centerline of the light emitter 450 and the bearing table 410 may be 45°, 40°, 35°, 30°, 25°, 20°, 15°, or the like

Optionally, the device 400 for laser processing defines a processing space 460 for placing workpieces and laser processing. The processing space 460 can be seen after an upper cover plate 401 is turned and opened.

The device 400 for laser processing of the embodiments of the present disclosure includes a frame 480 and a mounting bracket 440 mounted inside the frame 480, and the frame 480 defines the processing space 460. The camera 430 is disposed on the mounting bracket 440 inside the device 400 for laser processing. Compared to a solution where the camera 430 is mounted on the upper cover plate 401, the solutions of the embodiments of the present disclosure not only simplify a trace of the camera 430, but also better prevent changes of a position of the camera 430 caused by deformation of the cover plate 401 or repeated opening and closing of the cover plate 401, so as to avoid a recalibration before the laser processing, and to improve processing precision and efficiency. In addition, compared to the solution where the camera 430 is mounted on the cover plate 401, mounting the camera 430 on the mounting bracket 440 ensures that the picture of the whole part to be processed is captured, and reduces the height of the entire device 400 for laser processing, which is more convenient for a user to place the part to be processed (the user needs to stretch his hand deep into the processing space 460 or the frame 480 to place the part to be processed, and if the height of the device 400 for laser processing is too high, it is inconvenient for the user to operate).

The camera 430 is disposed at a middle position of the mounting bracket 440. In a case where the camera 430 is mounted at the middle position of the mounting bracket 440, an overall picture of the part to be processed can be better captured. The term “middle position” in this disclosure refers to the center of the part, or an area nears the center. Optionally, the mounting bracket 440 defines an accommodating groove 420. The accommodating groove 420 may be defined at the middle position of the mounting bracket 440. The camera 430 is positioned at the bottom of the accommodating groove 420. This can better prevent the camera 430 from being accidentally damaged when the part is to be processed, and also has a better dust-proof effect and improves the service life of the camera 430. In addition, the equivalent circle diameter of the accommodating groove gradually decreases from a surface of the mounting bracket 440 to the bottom of the accommodating groove, so as to better prevent sidewalls of the accommodating groove from affecting photographing of the camera.

In an embodiment, the camera 430 is disposed at the middle position of the mounting bracket 440. The light emitter 450 and the camera 430 may be disposed at one same side of the device 400 for laser processing, and the light emitter 450 is disposed on the surface of the mounting bracket 440 facing the bearing table. In some embodiments, a spacing between the light emitter 450 and the camera 430 is greater than or equal to 10 cm, for example, the spacing may be greater than 15 cm, 20 cm, or the like. Specifically, the spacing may be, but is not limited to, 10 cm, 12 cm, 15 cm, 18 cm, 20 cm, 22 cm, 25 cm, 28 cm, 30 cm, or the like. In this way, the light emitter 450 may effectively irradiate surfaces of the bearing table or parts to be processed of different thicknesses to produce corresponding changes, therefore making pictures of the parts to be processed obtained by the camera 430 have better quality, so that the device 400 for laser processing can determine more accurately the starting point for processing and process the part to be processed.

Optionally, the memory 490, as a non-transitory computer-readable storage medium, may be configured to store non-transitory software programs, non-transitory computer-executable programs, and non-transitory computer-executable modules, such as program instructions/modules corresponding to the method for calculating the starting point for processing of the embodiments of the present disclosure. The processor 470 executes various functional applications and data processing of the server, i.e., performs the method for calculating the starting point for processing of the above-described method embodiments, by running the non-transitory software programs, instructions, and modules stored in the memory 490.

Optionally, the processor 470 includes one or more general-purpose processors 470, where the general-purpose processor 470 may be any type of device capable of processing electronic instructions, including a central processing unit (CPU), a microprocessor, a microcontroller, a host processor, a controller, and an application specific integrated circuit (ASIC), etc. The processor 470 is configured to execute various types of digitally stored instructions, such as software or firmware programs stored in the memory 490, which enables the computing device to provide a wider variety of services.

Optionally, the memory 490 may be implemented as a random access memory (RAM), a read-only memory (ROM), an electrically erasable programmable read-only memory (EEPROM), a compact disc read-only memory (CD-ROM), or other optical disc storages, magnetic disk storage media or other magnetic storage devices, or any other media capable of being configured to carry or store desired program codes in the form of instructions or data structures and capable of being accessed by a computer. In addition, any connection may appropriately be a computer readable medium. For example, if the software is transmitted from a website, server, or other remote sources using coaxial cable, fiber optic cable, twisted pair cable, digital subscriber line (DSL), or wireless technologies such as infrared, radio, and microwave, then the coaxial cable, fiber optic cable, twisted pair cable, DSL, or such wireless technologies are included in the definition of the media to which they belong. As used in this disclosure, disks and discs include compact discs (CDs), laser discs, compact discs, digital disks (DVDs), floppy disks, and Blu-ray discs. The disks typically copy data magnetically, and discs copy data optically with lasers. The above combinations may also be included in the protection scope of computer-readable media.

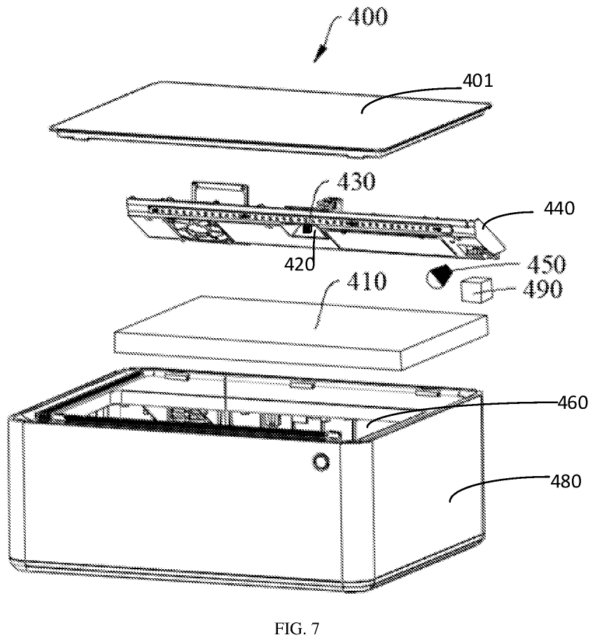

As illustrated in FIG. 7 and FIG. 9, the device for laser processing in the embodiments of the present disclosure further includes a laser head 480. The laser head 480 is electrically connected to the processor 470 and is configured to engrave, cut, and process the parts to be processed from the starting point for processing under the control of the processor 470.

For the same features of this embodiment as the above embodiments, reference can be made to the detailed descriptions in the above embodiments, which will not be repeated here.

The embodiments of the present disclosure also provide a computer-readable storage medium. The computer-readable storage medium is configured to store executable program codes, and the computer-executable program codes are configured to cause the computer to perform the method for calculating the starting point for processing of the embodiments of the present disclosure.

Reference herein to “embodiment” and “implementation” means that a particular feature, structure, or characteristic described in connection with the embodiment may be included in at least one embodiment of the present disclosure. An appearance of this term in various places in the specification is not necessarily referred to the same embodiment, nor is a separate or alternative embodiment mutually exclusive of other embodiments. It is understood explicitly and implicitly by those skilled in the art that embodiments described herein can be combined with other embodiments.

In the end, it is noted that, the above embodiments are only used to illustrate rather than limit the technical solutions of the present disclosure. Although the present disclosure is described in detail with reference to the above example embodiments, those of ordinary skill in the art may understand that modification and equivalent arrangements made to the present disclosure shall be within the spirit and scope of the technical solutions of the present disclosure.

What is claimed is:

1. A method for calculating a starting point for processing, performed by a device for laser processing and comprising:
establishing a first coordinate system and a second coordinate system, the first coordinate system comprising a CX-axis and being a coordinate system for a picture of a part to be processed;
capturing the picture of the part to be processed, and obtaining a first coordinate of a light spot on the CX-axis in the first coordinate system based on the picture, wherein the light spot is formed by irradiating the part to be processed by light emitted from a light emitter of the device for laser processing; and
calculating a second coordinate of the light spot in the second coordinate system based on the first coordinate, and determining the starting point for processing based on the second coordinate.

2. The method for calculating the starting point for processing of claim 1, wherein the second coordinate system comprises an X-axis, a Y-axis, and a Z-axis which are perpendicular to one another, and a plane defined by the X-axis and the Y-axis is parallel to a bearing table of the device for laser processing.

3. The method for calculating the starting point for processing of claim 2, wherein a point on the bearing table is used as an origin of the Z-axis in the second coordinate system, and two lines perpendicular to each other on a plane of the bearing table are used as the X-axis and the Y-axis in the second coordinate system.

4. The method for calculating the starting point for processing of claim 1, wherein determining the starting point for processing based on the second coordinate comprises:
using the second coordinate as the starting point for processing.

5. The method for calculating the starting point for processing of claim 1, wherein before capturing the picture of the part to be processed, and obtaining the first coordinate of the light spot on the CX-axis in the first coordinate system based on the picture, the method further comprises:
obtaining a relational expression between the first coordinate of the light spot on the CX-axis in the first coordinate system and the second coordinate of the light spot in the second coordinate system.

6. The method for calculating the starting point for processing of claim 5, wherein calculating the second coordinate of the light spot in the second coordinate system based on the first coordinate comprises:
calculating the second coordinate of the light spot in the second coordinate system based on the first coordinate and the relational expression.

7. The method for calculating the starting point for processing of claim 5, wherein obtaining the relational expression between the first coordinate of the light spot on the CX-axis in the first coordinate system and the second coordinate of the light spot in the second coordinate system comprises:
capturing a plurality of pictures of a plurality of parts to be processed or a plurality of pictures of the bearing table and a plurality of parts to be processed, wherein the plurality of parts to be processed all have different thicknesses;
obtaining a plurality of first calibrated coordinates of light spots on the plurality of pictures on the CX-axis in the first coordinate system based on the plurality of pictures;
measuring a plurality of second calibrated coordinates of light spots on the plurality of parts to be processed or on the bearing table and the plurality of parts to be processed in the second coordinate system, wherein each second calibrated coordinate comprises an X-axis coordinate, a Y-axis coordinate, and a Z-axis coordinate; and
performing a linear fitting on the plurality of first calibrated coordinates and the plurality of second calibrated coordinates to obtain the relational expression between the first coordinate and the second coordinate in the second coordinate system.

8. A device for laser processing, comprising:
a bearing table configured to bear a part to be processed;
a camera configured to capture a picture of the part to be processed; and
a light emitter configured to emit light towards the bearing table to form a light spot on a surface of the part to be processed; wherein
the device for laser processing further comprises a processor and a memory, the processor is electrically connected to the camera and the memory, the memory is configured to store program codes executable by the processor, and the program codes, when invoked and executed by the processor, are configured to cause the processor to perform:
establishing a first coordinate system and a second coordinate system, the first coordinate system comprising a CX-axis and being a coordinate system for a picture of a part to be processed;
capturing the picture of the part to be processed, and obtaining a first coordinate of a light spot on the CX-axis in the first coordinate system based on the picture, wherein the light spot is formed by irradiating the part to be processed by light emitted from a light emitter of the device for laser processing; and
calculating a second coordinate of the light spot in the second coordinate system based on the first coordinate, and determining the starting point for processing based on the second coordinate.

9. The device for laser processing of claim 8, wherein the second coordinate system comprises an X-axis, a Y-axis, and a Z-axis which are perpendicular to one another, and a plane defined by the X-axis and the Y-axis is parallel to a bearing table of the device for laser processing.

10. The device for laser processing of claim 9, wherein before capturing the picture of the part to be processed, and obtaining the first coordinate of the light spot on the CX-axis in the first coordinate system based on the picture, the program codes, when invoked and executed by the processor, are further configured to cause the processor to perform:
obtaining a relational expression between the first coordinate of the light spot on the CX-axis in the first coordinate system and the second coordinate of the light spot in the second coordinate system;
in terms of calculating the second coordinate of the light spot in the second coordinate system based on the first coordinate, the program codes, when invoked and executed by the processor, are configured to cause the processor to perform:
calculating the second coordinate of the light spot in the second coordinate system based on the first coordinate and the relational expression.

11. The device for laser processing of claim 10, wherein in terms of obtaining the relational expression between the first coordinate of the light spot on the CX-axis in the first coordinate system and the second coordinate of the light spot in the second coordinate system, the program codes, when invoked and executed by the processor, are further configured to cause the processor to perform:
capturing a plurality of pictures of a plurality of parts to be processed or a plurality of pictures of the bearing table and a plurality of parts to be processed, wherein the plurality of parts to be processed all have different thicknesses;
obtaining a plurality of first calibrated coordinates of light spots on the plurality of pictures on the CX-axis in the first coordinate system based on the plurality of pictures;
measuring a plurality of second calibrated coordinates of light spots on the plurality of parts to be processed or on the bearing table and the plurality of parts to be processed in the second coordinate system, wherein each second calibrated coordinate comprises an X-axis coordinate, a Y-axis coordinate, and a Z-axis coordinate; and
performing a linear fitting on the plurality of first calibrated coordinates and the plurality of second calibrated coordinates to obtain the relational expression between the first coordinate and the second coordinate in the second coordinate system.

12. The device for laser processing of claim 8, wherein an angle between a centerline of the light emitter and the bearing table is less than or equal to 45°.

13. The device for laser processing of claim 8, wherein the light emitter is configured to emit infrared light.

14. The device for laser processing of claim 8, wherein a plane defined by the camera and a first end of the bearing table is a first plane, and a plane defined by the camera and a second end of the bearing table is a second plane, and an angle between an optical axis of the camera and the first plane is equal to an angle between the optical axis of the camera and the second plane.

15. The device for laser processing of claim 8, wherein the device for laser processing comprises a frame and a mounting bracket, the frame defines a processing space, the mounting bracket is received in the processing space, and the camera is disposed on the mounting bracket.

16. The device for laser processing of claim 15, wherein the camera is disposed at a middle position of the mounting bracket; and
wherein the device for laser processing further comprises a cover plate, the cover plate is rotatably connected to the frame, and the cover plate is configured to rotate to open or close the processing space.

17. The device for laser processing of claim 15, wherein the mounting bracket defines an accommodating groove, an equivalent circle diameter of the accommodating groove decreases from an opening of the mounting bracket to bottom of the accommodating groove, and the camera is positioned at the bottom of the accommodating groove.

18. A non-transitory computer-readable storage medium, configured to store computer-executable program codes, the computer-executable program codes being configured to cause a computer to perform:
establishing a first coordinate system and a second coordinate system, the first coordinate system comprising a CX-axis and being a coordinate system for a picture of a part to be processed;
capturing the picture of the part to be processed, and obtaining a first coordinate of a light spot on the CX-axis in the first coordinate system based on the picture, wherein the light spot is formed by irradiating the part to be processed by light emitted from a light emitter of the device for laser processing; and
calculating a second coordinate of the light spot in the second coordinate system based on the first coordinate, and determining the starting point for processing based on the second coordinate.

19. The non-transitory computer-readable storage medium of claim 18, wherein the second coordinate system comprises an X-axis, a Y-axis, and a Z-axis which are perpendicular to one another, and a plane defined by the X-axis and the Y-axis is parallel to a bearing table of the device for laser processing;
before capturing the picture of the part to be processed, and obtaining the first coordinate of the light spot on the CX-axis in the first coordinate system based on the picture, the computer-executable program codes are configured to cause the computer to perform:
obtaining a relational expression between the first coordinate of the light spot on the CX-axis in the first coordinate system and the second coordinate of the light spot in the second coordinate system; and
in terms of calculating the second coordinate of the light spot in the second coordinate system based on the first coordinate, the computer-executable program codes are configured to cause the computer to perform:
calculating the second coordinate of the light spot in the second coordinate system based on the first coordinate and the relational expression.

20. The non-transitory computer-readable storage medium of claim 19, wherein in terms of obtaining the relational expression between the first coordinate of the light spot on the CX-axis in the first coordinate system and the second coordinate of the light spot in the second coordinate system, the computer-executable program codes are configured to cause the computer to perform:
capturing a plurality of pictures of a plurality of parts to be processed or a plurality of pictures of the bearing table and a plurality of parts to be processed, wherein the plurality of parts to be processed all have different thicknesses;
obtaining a plurality of first calibrated coordinates of light spots on the plurality of pictures on the CX-axis in the first coordinate system based on the plurality of pictures;
measuring a plurality of second calibrated coordinates of light spots on the plurality of parts to be processed or on the bearing table and the plurality of parts to be processed in the second coordinate system, wherein each second calibrated coordinate comprises an X-axis coordinate, a Y-axis coordinate, and a Z-axis coordinate; and
performing a linear fitting on the plurality of first calibrated coordinates and the plurality of second calibrated coordinates to obtain the relational expression between the first coordinate and the second coordinate in the second coordinate system.
